(19) United States
(12) Patent Application Publication
(10) Pub. No.: US 2018/0030377 A1
(43) Pub. Date: Feb. 1, 2018

(54) LIQUID DETERGENT OR CLEANING AGENT WITH SUSPENDED PARTICLES

(71) Applicant: Henkel AG & Co. KGaA, Duesseldorf (DE)

(72) Inventors: Peter Schmiedel, Duesseldorf (DE); Bent Rogge, Duesseldorf (DE); Danilo Panzica, Hilden (DE); Olga Morozova, Duesseldorf (DE); Kerstin Schmitz, Duesseldorf (DE)

(73) Assignee: Henkel AG & Co. KGaA, Duesseldorf (DE)

(21) Appl. No.: 15/730,342

(22) Filed: Oct. 11, 2017

Related U.S. Application Data
(63) Continuation of application No. PCT/EP2016/051429, filed on Jan. 25, 2016.

(30) Foreign Application Priority Data
Apr. 13, 2015 (DE) 10 2015 206 547.2

(51) Int. Cl. C11D 1/12; C11D 1/722; C11D 1/75; C11D 17/00; C11D 3/20; C11D 3/37; C11D 3/386; C11D 3/42; C11D 1/10; C11D 1/83

(52) U.S. Cl. CPC C11D 1/12; C11D 1/10; C11D 1/722; C11D 1/75; C11D 1/83; C11D 3/2065; C11D 3/3715; C11D 3/386; C11D 3/42; C11D 17/0013

(57) ABSTRACT

Particulate solids with an average particle diameter X_{50,3} of 0.01 mm to 3 mm, containing a total quantity of 30 to 100 wt. %, based on the total weight, of at least one polyester, containing at least one structural unit of the formula (I) and at least one structural unit of the formula (II), in which a and c each represents a number from 1 to 200 independently of each other. R², R⁵, and R⁶ each represents hydrogen or a C₁-C₁₈ n-alkyl group or a C₃-C₁₈ isoalkyl group independently of one another. R⁷ represents a linear or branched C₁-C₃₀ alkyl group or a linear or branched C₂-C₃₀ alkenyl group, a cycloalkyl group with 5 to 9 carbon atoms, a C₆-C₃₀ aryl group, or a C₆-C₃₀ arylalkyl group. The particulate solids can be suspended in liquid, water-containing surfactant compositions in a stable manner. The invention also relates to liquid detergent or cleaning agents containing (i) a liquid phase, which contains at least one surfactant and water, and (ii) solid particles, which are suspended in the liquid phase, and to the use of the particulate solids and a liquid phase, which contains water and surfactant, for producing a liquid detergent or cleaning agent.

### FIELD OF THE INVENTION

The invention relates to a liquid washing or cleaning agent comprising suspended particles.

### BACKGROUND OF THE INVENTION

Either ingredients that dissolve in the liquid phase of the agent or those that can be homogeneously suspended in undissolved form are an obvious choice for incorporation into liquid washing or cleaning agents. In the case of insoluble ingredients, a stable, homogeneous suspension is needed for the function and aesthetics of the washing or cleaning agent. Settled solid particles can result in clumping and in local excess concentrations of the ingredient during use, and thus in uneven dosing in the respective load of be washed. Visible clumping, and slimy precipitations or deposits of the solid ingredient on a transparent wall of the storage vessel, for example, additionally impair aesthetics.

The incorporation of multiple, possibly dyed, solid particles discernible as individualized particles to the naked human eye in suspension in a transparent or translucent liquid phase is often referred to as speckles. Corresponding particles, for this purpose, often have an appropriate particle size and offer aesthetic appeal to the consumer. The particle size, however, results in technical problems. Speckles should not dissolve, or swell drastically, in the hydrous liquid washing or cleaning agent. When used, however, the speckles should not deposit as residue on the substrate, such as textiles or the hard surface to be cleaned, in the form of solid matter, but should ideally dissolve or disintegrate over the course of the application, after the washing or cleaning medium has been produced, by dilution of the washing or cleaning agent with water. When active substances, and in particular polymeric active substances, are present in speckles, occasionally stain-like deposits form on the treated surface. This is the case, in particular, when the speckles have a high content of active substances, for example starting at 30 wt. % active substances based on the weight of the speckles.

### BRIEF SUMMARY OF THE INVENTION

It is the object of the present invention to provide liquid washing or cleaning agents that, in a (preferably transparent or translucent) liquid phase, comprise solid particles (speckles) discernible as individualized particles, which, despite the high content of active substance, do not dissolve in the hydrous liquid phase of the agent and, after use, do not leave behind any visible particulate or stain-like residue on the treated surface.

Surprisingly, it was found that this is achieved when a specific (preferably anionic) polyester is used as the base material for the speckles and as the active substance, in which additional ingredients, and in particular polymeric active substances, can be incorporated.

A first subject matter of the invention thus relates to a liquid washing or cleaning agent, comprising:
(i) a liquid phase, comprising at least one surfactant and water, and
(ii) solid particles, suspended in the liquid phase, having a mean particle diameter X_{50,3} of 0.01 mm to 3 mm, comprising, based on the weight of the solid particles, a total amount of 30 to 100 wt. %, preferably 50 to 100 wt. %, and particularly preferably 75 to 100 wt. % of at least one polyester, comprising at least one structural unit of formula (I) and at least one structural unit of formula (II)

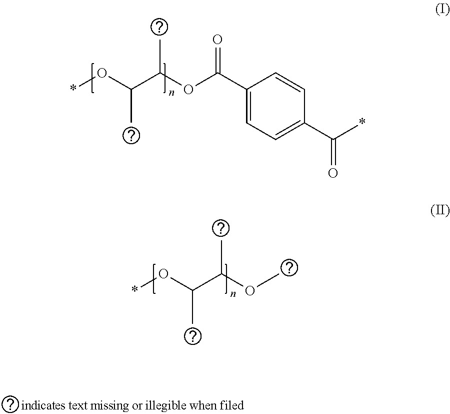

where
a and b, independently of one another, each denote a number from 1 to 200;
R¹, R², R⁵ and R⁶, independently of one another, each denote hydrogen or a C₁-C₁₈-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group.

According to the definition of the invention, a substance is solid (in solid form) when it is present in the solid state of aggregation at 25° C. and 1013 mbar.

According to the definition of the invention, a substance is liquid when it is present in the liquid state of aggregation at 25° C. and 1013 mbar.

A chemical compound is an organic compound when the molecule of the chemical compound comprises at least one covalent bond between the carbon and the hydrogen.

Conversely to the definition of the organic compound, a chemical compound is an inorganic compound when the molecule of the chemical compound comprises no covalent bond between the carbon and the hydrogen.

The average particle diameter X_{50,3} is the volume median of the particles (measured after storage of the solid particles in the climatic test cabinet for 24 hours at 30° C. and 50% relative humidity, and prior to incorporation in the liquid phase of the agent according to the invention, such as by way of screen analysis or by way of a Camsizer particle size analyzer from Retsch). The average particle diameter of the suspended solid matter is explicitly only based on the suspended particles present in the agent according to the invention, which, prior to incorporation in the agent according to the invention (after storage in the climatic test cabinet for 24 hours at 30° C. and 50% relative humidity), comprise 30 to 100 wt. %, preferably 50 to 100 wt. %, and particularly preferably 75 to 100 wt. % of at least one described anionic polyester.

It is especially particularly preferred when the agent according to the invention comprises solid particles, suspended in the liquid phase, having an average particle diameter X_{50,3} of 0.01 mm to 3 mm, comprising, based on the weight of the solid particles, a total amount of 30 to 100 wt. %, preferably 50 to 100 wt. %, and particularly preferably 75 to 100 wt. % of at least one anionic polyester, comprising at least one structural unit of formula (I), at least one structural unit of formula (II) and at least one structural unit of formula (III)

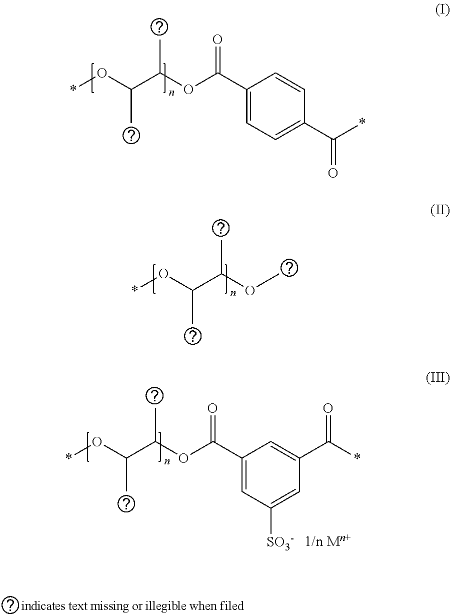

where
a, b and c, independently of one another, each denote a number from 1 to 200;
1/n Mⁿ⁺ denotes an equivalent of a cation having the charge number n, where n=1, 2 or 3;
R¹, R², R³, R⁴, R⁵ and R⁶, independently of one another, each denote hydrogen or a C₁-C₁₈-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group. This preferred polyester is referred to hereafter as anionic polyester.

A chemical bond in formulas (I), (II), (III) identified by * denotes a free valence of the corresponding structural element, which forms an ester linkage in the polymer backbone of the polyester, for example either with one of the described structural elements of formula (I) or of formula (III), or with a further at least bivalent structural element. To form a polymer terminus, these valences of formula (I) or (III) bind to the structural element of formula (II), forming an ester linkage, or to a further, monovalent structural element.

The (preferably anionic) polyesters according to the invention are copolyesters, which can be formed at least of monomers that, after a polymerization reaction, yield corresponding structural units of formulas (I) and (II), and preferably (III), at least in the polymer backbone. Such polyesters can be obtained, for example, by way of a polycondensation reaction of terephthalic acid dialkyl esters (and preferably 5-sulfoisophthalic acid dialkyl esters) and alkylene glycols, and optionally polyalkylene glycols (where a, b and/or c>1), and polyalkylene glycols end-capped at one end. The synthesis of the (preferably anionic) polyesters according to the invention can take place according to known methods, for example by initially heating the above-mentioned components at normal pressure, adding a catalyst, and then creating the necessary molecular weights under vacuum by distilling off hyperstoichiometric amounts of the glycols used. The known transesterification and condensation catalysts, such as titanium tetraisopropylate, dibutyltin oxide, alkali or alkaline earth metal alcoholates or antimony trioxide/calcium acetate, are suitable for the reaction. With respect to further details, reference is made to EP 442 101.

The described structural units can be present either in block form or in statistically distributed form in the polyester molecule of the described anionic polyester.

Preferred suspended polyester-containing solid particles preferably have an average particle diameter (volume median) X_{50,3} of 1 mm to 2 mm (as described above, after storage in the climatic test cabinet for 24 hours at 30° C. and 50% relative humidity, measured by way of screen analysis or by way of a Camsizer particle size analyzer from Retsch).

It is preferred according to the invention when the total amount of the (preferably anionic) polyester present in the suspended solid particles has a number average of 1 to 50 structural units of formula (I) and 1 to 50 structural units of formula (III). Since this is the number average of the respective structural units, calculated via the total amount of the (preferably anionic) polyester present in the suspended solid phase, the values of these number averages and of the following number averages from the number of structural units are rational numbers.

It is again preferred when the total amount of the (particularly preferably anionic) polyester present in the suspended solid particles has, in each case a number average of,
between 1 and 25, in particular between 1 and 10, particularly preferably between 1 and 5 structural units of formula (I), and
between 0.05 and 15, in particular between 0.1 and 10, and particularly preferably between 0.25 and 3 structural units of formula (II), and
when anionic, particularly preferably between 1 and 30, in particular between 2 and 15, and particularly preferably between 3 and 10 structural units of formula (III).

The (preferably anionic) polyesters, comprising the structural units (I), (II) and preferably (III) (and optionally (IV) vide supra), preferably have number average molecular weights in the range of 700 to 50,000 g/mol, wherein the number average molecular weight can be determined by way of size exclusion chromatography in an aqueous solution, using calibration, with the aid of narrowly distributed polyacrylic acid Na salt standards. The number average molecular weights are preferably in the range of 800 to 25,000 g/mol, in particular 1,000 to 15,000 g/mol, and particularly preferably 1,200 to 12,000 g/mol.

It is preferred according to the invention when 1/n Mⁿ⁺ according to formula (III) is Li⁺, Na⁺, K⁺, ½ Mg²⁺, ½ Ca²⁻, ⅓ Al³⁺, NH₄⁺, monoalkylammonium, dialkylammonium, trialkyammonium or tetraalkylammonium, wherein the alkyl functional groups of the ammonium ions are C₁-C₂₂ alkyl functional groups or C₂-C₁₀ hydroxyalkyl functional groups, or arbitrary mixtures thereof.

Preferred anionic polyesters are those in which, corresponding to formulas (I), (II) and (III),
R¹, R², R³, R⁴, R⁵ and R⁶, independently of one another, each denote hydrogen or methyl; and
R⁷ denotes methyl, and/or
a, b and c, independently of one another, each denote a number from 1 to 200, in particular 1 to 20, particularly preferably 1 to 5, and exceptionally preferably a and b=1, and/or
c is a number from 2 to 10.

It is again preferred when the total amount of the described (particularly preferably anionic) polyester present in the suspended solid particles has, in each case a number average of,
between 1 and 25, in particular between 1 and 10, and particularly preferably between 1 and 5 structural units of formula (I), and
between 0.05 and 15, in particular between 0.1 and 10, and particularly preferably between 0.25 and 3 structural units of formula (II), and
particularly preferably additionally between 1 and 30, in particular between 2 and 15, and particularly preferably between 3 and 10 structural units of formula (III).

Especially particularly preferred anionic polyesters are those in which, corresponding to formulas (I), (II) and (III),
R¹, R², R³, R⁴, R⁵ and R⁶, independently of one another, each denote hydrogen or methyl;
R⁷ denotes methyl; and
a, b and c, independently of one another, each denote a number from 1 to 200, in particular 1 to 20, particularly preferably 1 to 5, and exceptionally preferably a and b=1, and
c is a number from 2 to 10,
wherein the total amount of the described anionic polyesters present in the suspended solid particles has a number average of
between 1 and 25, in particular between 1 and 10, and particularly preferably between 1 and 5 structural units of formula (I),
between 0.05 and 15, in particular between 0.1 and 10, and particularly preferably between 0.25 and 3 structural units of formula (II), and
between 1 and 30, in particular between 2 and 15, and particularly preferably between 3 and 10 structural units of formula (III).

Such polyesters can be obtained, for example, by way of a polycondensation reaction of terephthalic acid dialkyl esters, 5-sulfoisophthalic acid dialkyl esters, alkylene glycols, optionally polyalkylene glycols (where a, b and/or c>1), and polyalkylene glycols end-capped at one end (corresponding to unit of formula II).

The unit of formula (I) used can be a terephthalic acid ester comprising one or more difunctional, aliphatic alcohols, and preferably ethylene glycol (R¹ and R² each H) and/or 1,2-propylene glycol (R¹═H and R²═—CH₃, or vice versa) and/or shorter chain polyethylene glycols and/or poly[ethylene glycol-co-propylene glycol] having number average molecular weights of 100 to 2000 g/mol.

The non-ionic polyalkylene glycol monoalkyl ethers end-capped at one end according to the unit of formula (II) used are preferably poly[ethylene glycol-co-propylene glycol]-monomethyl ethers having number average molecular weights of 100 to 2000 g/mol, and polyethylene glycol monomethyl ethers of general formula CH₃—O—(C₂H₄O)ₙ—H, where n=1 to 99, in particular 1 to 20, and particularly preferably 2 to 10. Since the use of such ethers end-capped at one end predefines the theoretical maximum average molecular weight of a polyester structure that can be achieved with quantitative yield, the preferred usage amount of the structural unit (II) is that which is needed to reach preferred average molecular weights (vide supra).

The unit of formula (III) used can be a 5-sulfoisophthalic acid ester having one or more difunctional, aliphatic alcohols, and preferably those mentioned above are used.

### DETAILED DESCRIPTION OF THE INVENTION

In a special embodiment of the invention, the (preferably anionic) polyester present according to the invention additionally comprises at least one structural unit of formula IV,

-[polyfunctional unit-]_{g} (IV)

where
g is a number from 0 to 5, and
polyfunctional unit denotes a unit having 3 to 6 free valences, which are able to bind to the polymer structure via ester groups.

In addition to linear polymers, which result from the structural units (I), (II) (and preferably (III)), the use of crosslinked or branched polyester structures is also in accordance with the invention. This is expressed by the presence of a polyfunctional structural unit (IV) acting in a crosslinking manner, having at least three to a maximum of 6 functional groups empowered to carry out the esterification reaction. Functional groupings that can be mentioned here are acid, alcohol, ester, anhydride or epoxy groups, for example. Different functionalities in one molecule are also possible. Examples in this regard include citric acid, malic acid, tartaric acid and gallic acid, and particularly preferably 2,2-dihydroxymethyl propionic acid. Furthermore, polyhydric alcohols such as pentaerythrol, glycerol, sorbitol and/or trimethylol propane can be used. These can also be polyvalent aliphatic or aromatic carboxylic acids, such as benzene-1,2,3-tricarboxylic acid (hemimellitic acid), benzene-1,2,4-tricarboxylic acid (trimellitic acid), or benzene-1,3,5-tricarboxcylic acid (trimesic acid). The percent by weight of crosslinking monomers, based on the total weight of the anionic polyester, can be up to 10 wt. %, in particular up to 5 wt. %, and especially preferably up to 3 wt. %, for example.

According to the invention, solid (particularly preferably anionic) polyesters having softening points above 40° C. are preferably used; preferably, these have a softening point between 50 and 200° C., particularly preferably between 80° C. and 150° C., and exceptionally preferably between 100° C. and 120° C.

It is preferred according to the invention when the suspended particulate solid matter has a shape factor of at least 0.80, 0.84, 0.86, 0.87, 0.88, 0.89, 0.91, 0.92, 0.93, 0.94, 0.96, 0.97, 0.98, 0.99 or 1. The shape factor can be precisely determined by way of modern particle measuring techniques using digital image processing. A typical particle shape analysis, as it can be carried out, for example, by way of the Camsizer® system from Retsch Technology or the KeSizer® from Kemira, is based on irradiating the particles, or the bulk materials, using a light source, and capturing the particles as projection surfaces, and digitizing and processing these using a computer. The surface curvature is determined by way of an optical measuring method, in which the “shadow” cast by the parts to be analyzed is determined and converted into a corresponding shape factor. Shape factor=4*pi*A/U (A=projection surface of the particle; U=circumference of the particle). A shape factor=1 applies to spheres; particle shapes deviating therefrom have a value <1. The underlying principle for determining the shape factor was described, for example, by Gordon Rittenhouse in “A Visual method of estimating two-dimensional sphericity” in the Journal of Sedimentary Petrology, Vol. 13, No. 2, pages 79-81. The measuring limits of this optical analysis method are 15 μm or 90 mm.

In principle, the described particulate solid matter can be obtained by way of spraying and subsequent dry compression, by way of granulation, spray agglomeration or by way of extrusion, and optionally by way of rounding.

Anionic polyesters used have a solid consistency and can preferably be easily ground to powder, or be compacted or agglomerated to granules having defined particle sizes. The granulation can take place such that the copolymers developing in the form of a melt during synthesis are solidified to form flakes by cooling these in a cool gas flow, for example air or nitrogen, or by applying these to a flaking roller or to a conveyor belt. This coarse product can, optionally, be ground further, for example in a cylinder mill or in a sieve mill, which can be followed by sifting and rounding. The granulation can also take place in such a way that the polyesters are ground to powder after solidification, and subsequently are converted into granules having defined particle sizes by way of compaction or agglomeration and rounding.

The spray agglomeration method offers the advantage that the production of the described particles and rounding take place in one step. In the spray agglomeration method, the particles are simultaneously agglomerated and dried in a fluidized bed. By applying the substances in an onion-like layered manner and by moving the particles, very dense and round particles are created.

Another possible method for producing the described particles is to initially produce pourable particles, preferably by way of extrusion, and the particles are subsequently rounded, preferably by way of a spheronizer, a rotary drum, a drum coater or a coating plate. Extrusion methods suitable for this purpose are known from the prior art and are described, for example, in the international patent application WO 00/23556, in the international patent application WO 99/13045, or in the European patent application EP 0 665 879.

The extrusion process particularly preferably takes place using a twin screw extruder. Initially, the raw materials intended for the respective particle, including the described anionic polyesters, are mixed and subsequently homogenized and plasticized in the extruder. By cutting the extruded mass at the extruder head, cylindrically shaped particles can be obtained, for example. The particles thus obtained are preferably rounded in a second method step. Rounding preferably takes place such that the particles have a shape factor of at least 0.80 after the rounding process.

Preferably, the particles are, or the extrudate is, rounded with the aid of what is known as a spheronizer, a rotary drum, a drum coater or a coating plate.

If desired, dyes can be applied to the surface of the suspended particulate solid matter, advantageously during the rounding step, wherein the particles can be dyed in different colors.

In one embodiment of the invention, the described particles are dyed in a color other than white. Preferred dyes are Acid Red 18 (C1 16255), Acid Red 26, Acid Red 27, Acid Red 33, Acid Red 51, Acid Red 87, Acid Red 88, Acid Red 92, Acid Red 95, Acid Red 249 (C1 18134), Acid Red 52 (C1 45100), Acid Violet 126, Acid Violet 48, Acid Violet 54, Acid Yellow 1, Acid Yellow 3 (C1 47005), Acid Yellow 11, Acid Yellow 23 (C1 19140), Acid Yellow 3, Direct Blue 199 (C1 74190), Direct Yellow 28 (C1 19555), Food Blue 2 (C1 42090), Food Blue 5:2 (C1 42051:2), Food Red 7 (01 16255), Food Yellow 13 (C1 47005), Food Yellow 3 (C1 15985), Food Yellow 4 (C1 19140), Reactive Green 12, and Solvent Green 7 (C1 59040). Water-soluble acid dyes are particularly preferred dyes, such as Food Yellow 13 (Acid Yellow 3, C1 47005), Food Yellow 4 (Acid Yellow 23, C1 19140), Food Red 7 (Acid Red 18, C1 16255), Food Blue 2 (Acid Blue 9, C1 42090), Food Blue 5 (Acid Blue 3, C1 42051), Acid Red 249 (C1 18134), Acid Red 52 (C1 45100), Acid Violet 126, Acid Violet 48, Acid Blue 80 (01 61585), Acid Blue 182, Acid Blue 182, Acid Green 25 (C1 61570), and Acid Green 81. The use of water-soluble direct dyes is likewise preferred, such as Direct Yellow 28 (C1 19555), Direct Blue 199 (C1 74190), as well as water-soluble reactive dyes, such as Reactive Green 12, and the dyes Food Yellow 3 (C1 15985), Acid Yellow 184. The use of aqueous dispersions of the following pigment dyes is likewise preferred: Pigment Black 7 (C1 77266), Pigment Blue 15 (C1 74160), Pigment Blue 15:1 (074160), Pigment Blue 15:3 (C1 74160), Pigment Green 7 (C1 74260), Pigment Orange 5, Pigment Red 112 (C1 12370), Pigment Red 112 (C1 12370), Pigment Red 122 (C1 73915), Pigment Red 179 (C1 71130), Pigment Red 184 (C1 12487), Pigment Red 188 (C1 12467), Pigment Red 4 (C1 12085), Pigment Red 5 (C1 12490), Pigment Red 9, Pigment Violet 23 (C1 51319), Pigment Yellow 1 (C1 28 11680), Pigment Yellow 13 (C1 21100), Pigment Yellow 154, Pigment Yellow 3 (C1 11710), Pigment Yellow 74, Pigment Yellow 83 (C1 21108), and Pigment Yellow 97. In preferred embodiments, the following pigment dyes are used in the form of dispersions: Pigment Yellow 1 (C1 11680), Pigment Yellow 3 (C1 11710), Pigment Red 112 (C1 12370), Pigment Red 5 (C1 12490), Pigment Red 181 (C1 73360), Pigment Violet 23 (C1 51319), Pigment Blue 15: 1 (C1 74160), Pigment Green 7 (C1 74260), and Pigment Black 7 (C1 77266). In likewise preferred embodiments, water-soluble polymer dyes are used, such as Liquitint®, Liquitint Blue HP®, Liquitint Blue 65®, Liquitint Patent Blue®, Liquitint Royal Blue®, Liquitint Experimental Yellow 8949-43®, Liquitint Green HMC®, Liquitint Yellow II®, and mixtures thereof.

The suspended particulate solid matter can consist entirely of at least one described anionic polyester (vide supra). In addition to the described anionic polyester, the suspended solid particles can, in principle, additionally comprise arbitrary customary ingredients of washing or cleaning agents, wherein care must be taken here, as in all other instances, that ingredients that are not compatible with one another are not incorporated together in a particle because otherwise the shelf life of the agents will be reduced.

In a further embodiment, the suspended solid particles additionally comprise at least one further ingredient.

It is particularly preferred according to the invention when the suspended solid particles additionally comprise at least one further ingredient, selected from plasticizer, plasticizing auxiliary, enzyme, enzyme stabilizer, complexing agent for metals, such as aminopolycarboxylic acids, aminohydroxypolycarboxylic acids, polyphosphonic acids and/or aminopolyphosphonic acids, graying inhibitors, such as cellulose ethers, dye transfer inhibitors, such as polyvinylpyrrolidone or polyvinylpyridine-N-oxide, sud suppressors, such as organopolysiloxanes or paraffins, optical brighteners, such as stilbene disulfonic acid derivatives, scents or density setting agents, or mixtures thereof.

It is particularly preferred according to the invention when the suspended solid particles additionally comprise at least one further polymeric ingredient (in particular, selected from polymeric graying inhibitors and polymeric dye transfer inhibitors).

It is preferred according to the invention when the suspended solid particles additionally comprise at least one plasticizing auxiliary, selected from triethyl citrate, triacetin, 1,2-propylene glycol, glycerol, 2-methyl-1,3-propylene glycol, water or mixtures thereof.

The plasticizing auxiliary is preferably present in a total amount of 0 to 15 wt. % in the described suspended solid particles.

Enzymes that, optionally, are additionally present in the described suspended solid particles are preferably selected from the group consisting of protease, amylase, pullulanase, mannanase, lipase, cellulase, hemicellulase, oxidase, peroxidase, pectate lyase, or mixtures thereof. Primarily, protease obtained from microorganisms, such as bacteria or fungi, may be used. This may be obtained in the known manner from suitable microorganisms by way of fermentation processes. Proteases are commercially available, for example, under the names BLAP®, Savinase®, Esperase®, Maxatase®, Optimase®, Alcalase®, Durazym® or Maxapem®.

The lipase that can be used can be obtained from Humicola lanuginosa, from Bacillus species, from Pseudomonas species, from Fusarium species, as is described in the European patent application, for example, from Rhizopus species or from Aspergillus species. Suitable lipases are commercially available, for example, under the names Lipolase®, Lipozym®, Lipomax®, Amano® lipase, Toyo-Jozo® lipase, Meito® lipase and Diosynth® lipase. Suitable amylases are commercially available, for example, under the names Maxamyl® and Termamyl®.

The cellulase that can be used can be an enzyme obtainable from bacteria or fungi, which preferably has an optimal pH value in the slightly acidic to slightly alkaline range of 6 to 9.5.

Suitable suds suppressors include long-chain soaps, in particular behenic soap, fatty acid amides, paraffins, waxes, microcrystalline waxes, organopolysilxanes and the mixtures thereof, which moreover can comprise microfine silicic acid that is optionally silanated or hydrophobized in another manner. For use in suspended, described solid particles according to the invention, such suds suppressors are preferably bound to granular, water-soluble carrier substances.

Furthermore, the described suspended, solid particle according to the invention can comprise at least one graying inhibitor. The task of graying inhibitors is to keep the dirt dissolved from the fibers suspended in the liquor, and thus prevent graying of the fibers Water-soluble colloids, usually of an organic nature, are suitable for this purpose, such as water-soluble salts of polymeric carboxylic acids, glue, gelatins, salts of ether carboxylic acids or ether sulfonic acids of starch or cellulose, or salts of acidic sulfuric acid esters of cellulose or starch. Water-soluble, acid group-containing polyamides are also suitable for this purpose. Furthermore, soluble starch preparations and starch products other than those mentioned above can be used, such as partially hydrolyzed starch. The use of Na-carboxymethyl cellulose, methyl cellulose, methyl hydroxyethyl cellulose and the mixtures thereof is preferred.

Density setting agents are used to set the density of a solid particle. The density setting agents preferably have a lower density than the substance/the substance mixture in the particles of which the density setting agent is to be incorporated. The use of the density setting agents, for example, prevents the sedimentation of a solid particle type in a particle mixture comprising differing solid particles having differing densities by setting the density of all particles so as to be substantially homogeneous. Additionally, the sedimentation of particles suspended in a liquid medium can be decreased.

Preferred density setting agents according to the invention are selected from glass particles and/or porous particles comprising at least one cavity.

It is particularly preferred according to the invention when the described suspended, solid particles comprise less than 5 wt. %, particularly preferably less than 2 wt. %, and especially particularly preferably less than 1 wt. % surfactant (based on the weight of the described particles after storage in a climatic test cabinet for 24 hours at 30° C. and 50% relative humidity and prior to incorporation in the liquid phase of the agent according to the invention).

A particularly preferred particulate solid matter suspended in the agent according to the invention comprises, based on the total weight,
(i) 50 to 99 w% of at least one described polyester (in particular, selected from aforementioned preferred embodiments of the (particularly preferably anionic) polyester), and
(ii) 1 to 15 wt. % of at least one plasticizing auxiliary (preferably selected from triethyl citrate, triacetin, 1,2-propylene glycol, glycerol, 2-methyl-1,3-propylene glycol, water, or mixtures thereof), and
(iii) 0 to 49 wt. % of at least one further ingredient, selected from enzyme, enzyme stabilizer, complexing agent for heavy metals, such as aminopolycarboxylic acids, aminohydroxypolycarboxylic acids, polyphosphonic acids and/or aminopolyphosphonic acids, graying inhibitors, such as cellulose ether, dye transfer inhibitor, such as polyvinylpyrrolidone or polyvinylpyridine-N-oxide, suds suppressor, such as organopolysiloxanes or paraffins, optical brightener, such as stilbene disulfonic acid derivatives, scents, density setting agent, dye, or mixtures thereof.

The liquid phase of the washing or cleaning agent according to the invention preferably has a yield point. The yield point refers to the smallest tension (force per unit area) above which a plastic substance behaves rheologically like a fluid. The yield point is indicated in Pascal (Pa). It is preferred according to the invention when the liquid phase has a yield point of at least 0.4 Pa (23° C.), and particularly preferably of at least 0.6 Pa (23° C.).

The yield points of the washing or cleaning agents were measured by way of a rotational rheometer from TA Instruments, type AR G2. This is what is known as a shear stress-controlled rheometer.

Various methods are described in the literature for measuring a yield point by way of a shear stress-controlled rheometer, which are known to a person skilled in the art.

To determine the yield points within the scope of the present invention, the procedure at 23° C. was as follows:

In the rheometer, the samples were subjected to rising shear stress s(t) over time. For example, the shear stress can be increased over the course of 10 minutes from the smallest possible value (such as 2 mPa) to 10 Pa, for example. The deformation γ of the sample is measured as a function of this shear stress. The deformation γ is plotted in a log-log plot against the shear stress. If the analyzed sample has a yield point, two areas can be clearly distinguished in this plot. Purely elastic deformation is found below a certain shear stress level. The slope of the curve γ(σ) (log-log plot) in this area is one. Above this shear stress, the yield point sets in, and the slope of the curve is suddenly higher. The shear stress at which the curve bends, which is to say the transition from elastic to plastic deformation, marks the yield point. The yield point can be conveniently determined by applying tangents to the two curve sections. Samples without a yield point do not exhibit the characteristic bend in the function γ(σ).

It is particularly preferred according to the invention when the liquid phase of the washing or cleaning agent according to the invention comprises:
water;
5 to 20 wt. % anionic surfactant selected from the group consisting of sulfonate surfactants, sulfate surfactants and mixtures thereof;
0.4 to 6 wt. % of a co-surfactant selected from the group consisting of alkoxylated C₈-C₁₈ fatty alcohols having a degree of alkoxylation of 3, aliphatic C₆-C₁₄ alcohols, aromatic C₆-C₁₄ alcohols, aliphatic C₆-C₁₂ dialcohols, monoglycerides of C₁₂-C₁₈ fatty acids, monoglycerol ethers of C₈-C₁₈ fatty alcohols, and mixtures thereof;
1 to 15 wt. of the non-ionic surfactant different from the described co-surfactant (preferably selected from the group consisting of alkoxylated fatty alcohols having a degree of alkoxylation ≧4, alkoxylated fatty acid alkyl esters, fatty acid amides, alkoxylated fatty acid amides, polyhydroxy fatty acid amides, alkylphenol polyglycol ethers, amine oxides, alkyl polyglucosides, and mixtures thereof); and
0.5 to 10 wt. % of an organic salt.

It has been shown that adding select amounts of an inorganic salt and of a specific co-surfactant to a liquid phase comprising anionic and non-ionic surfactants yields a washing or cleaning agent having a yield point in which the anionic polyester-containing solid particle according to the invention can be incorporated in a particularly stable manner. Without the addition of a polymeric thickener, this washing or cleaning agent is able to disperse particles in a stable manner. The possibility to dispense with polymeric thickeners not only has the advantage that the agents can be produced more easily and more cost-effectively, but additionally undesirable side effects of a polymeric thickener, such as graying when treating textiles, can be avoided. Accordingly, in a preferred embodiment, the washing or cleaning agent is free of polymeric thickener. Furthermore, the washing or cleaning agent is also stable without adding another polymeric stabilizer or dispersing agent. Moreover, the washing or cleaning agents can be used without difficulty in automatic washing or cleaning agents since the content of inorganic salt is considerably reduced compared to washing or cleaning agents known from the prior art.

It is preferred that the anionic surfactant is selected from the group consisting of C₉₋₁₃ alkylbenzene sulfonates, olefin sulfonates, C₁₂₋₁₈ alkane sulfonates, ester sulfonates, alk(en)yl sulfates, fatty alcohol ether sulfates and mixtures thereof.

It has been shown that these sulfonate and sulfate surfactants are particularly well-suited for producing stable liquid washing agents having a yield point.

Surfactants of the sulfonate type that can be used are preferably C₉₋₁₃ alkylbenzene sulfonates, olefin sulfonates, which is to say mixtures of alkene and hydroxyalkane sulfonates, and disulfonates, as they are obtained, for example, from C₁₂₋₁₈ monoolefins having a terminal or internal double bond by way of sulfonation with gaseous sulfur trioxide and subsequent alkaline or acid hydrolysis of the sulfonation products. Also suitable are C₁₂₋₁₈ alkane sulfonates and the esters of α-sulfofatty acids (ester sulfonates), for example the α-sulfonated methyl esters of hydrogenated coconut, palm kernel or tallow fatty acids.

The alkali salts, and in particular the sodium salts of the sulfuric acid half-esters of C₁₂-C₁₈ fatty alcohols, for example from coconut fatty alcohol, tallow fatty alcohol, lauryl, myristyl, cetyl or stearyl alcohol, or of C₁₀-C₂₀ oxo alcohols and the half-esters of secondary alcohols having this chain length are preferred alk(en)yl sulfates. From a washing perspective, the C₁₂-C₁₆ alkyl sulfates, C₁₂-C₁₅ alkyl sulfates, and C₁₄-C₁₅ alkyl sulfates are preferred. 2,3-alkyl sulfates are also suitable anionic surfactants.

Fatty alcohol ether sulfates, such as the sulfuric acid monoesters of straight-chain or branched C₇₋₂₁ alcohols ethoxylated with 1 to 6 moles of ethylene oxide, such as 2-methyl-branched C₉₋₁₁ alcohols having, on average, 3.5 moles ethylene oxide (EO) or C₁₂₋₁₈ fatty alcohols having 1 to 4 EO, are also suited.

It is preferred that the liquid washing or cleaning agent comprises a mixture of sulfonate and sulfate surfactants. In a particularly preferred embodiment, the liquid washing or cleaning agent comprises C₉₋₁₃ alkylbenzene sulfonates and fatty alcohol ether sulfates as the anionic surfactant. The ratio of the sulfate surfactants to sulfonate surfactants is preferably in the range of 3:1 to 1:3, and more preferably in the range of 3:1 to 1:1. In a particularly preferred embodiment, the liquid washing or cleaning agent comprises fatty alcohol ether sulfates and C₉₋₁₃ alkylbenzene sulfonates in a ratio of 2:1.

In addition to the anionic surfactant, the liquid washing or cleaning agent can comprise soaps. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut oil, palm kernel oil, olive oil, or tallow fatty acids.

The anionic surfactants and the soaps may be present in the form of the sodium, potassium, magnesium or ammonium salts thereof. The anionic surfactants are preferably present in the form of the sodium salts thereof. Further preferred counterions for the anionic surfactants are also the protonated forms of choline, triethylamine, monoethanolamine or methyl ethyl amine.

The amount of soap in the liquid washing or cleaning agent is preferably up to 5 wt. %, and more preferably up to 2 wt., based on the total amount of washing or cleaning agent.

It is preferred according to the invention when the agent according to the invention comprises at least one compound selected from alkoxylated C₈-C₁₈ fatty alcohol having a degree of alkoxylation of ≦3, aliphatic C₆-C₁₄ alcohols, monoglycerides of C₁₂-C₁₈ fatty acids or mixtures thereof as the co-surfactant.

The alkoxylated C₈-C₁₈ fatty alcohol having a degree of alkoxylation of ≦3 that may be used is, in particular, at least one appropriately alkoxylated fatty alcohol having a degree of ethoxylation of ≦3.

Alkoxylated C₈-C₁₅ fatty alcohols having a degree of alkoxylation of ≦3 are especially particularly preferred, wherein, once again, most preferably at least one appropriately alkoxylated C₈-C₁₅ fatty alcohol having a degree of alkoxylation of ≦3 may be used.

Typical examples of monoglycerol esters of C₁₂-C₁₈ fatty alcohols are those based on lauryl alcohol, isotridecyl alcohol, myristyl alcohol, palmityl alcohol, palmoleyl alcohol, stearyl alcohol, isostearyl alcohol, oleyl alcohol, linolyl alcohol, linolenyl alcohol, and the technical mixtures thereof.

It is furthermore particularly preferred when the co-surfactant is a combination of at least one alkoxylated C₈-C₁₈ fatty alcohol having a degree of alkoxylation of ≦3 and at least one aliphatic C₆-C₁₄ alcohol. It is, once again, especially particularly preferred when the agent according to the invention comprises a combination of at least one alkoxylated C₈-C₁₈ fatty alcohol having a degree of alkoxylation of ≦3 and at least one aliphatic C₆-C₁₄ alcohol as the co-surfactant in a total amount of 0.5 to 6 wt. %. It is especially particularly preferred when the agent according to the invention comprises at least one alkoxylated C₈-C₁₈ fatty alcohol having a degree of alkoxylation of ≦3 in a total amount of 0.4 to 5.0 wt. %, and at least one aliphatic C₆-C₁₄ alcohol, and in particular 0.1 to 1.0 wt. % of at least one branched aliphatic C₆-C₁₄ alcohol.

In addition to the anionic surfactant, the washing or cleaning agent also comprises a non-ionic surfactant. The non-ionic surfactant comprises alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkylpolyglucosides and mixtures thereof.

The content of non-ionic surfactant is preferably 3 to 15 wt. %, and particularly preferably 4 to 10 wt. %, each based on the total washing or cleaning agent.

Alkoxylated, advantageously ethoxylated, in particular primary alcohols having preferably 8 to 18 carbon atoms and on average 4 to 12 moles ethylene oxide (EO) per mole of alcohol, in which the alcohol residue can be linear or preferably methyl-branched at the 2-position or can comprise linear and methyl-branched functional groups in the mixture, such as those usually present in oxo alcohol groups, are preferred as the non-ionic surfactant. However, in particular, alcohol ethoxylates comprising linear functional groups of alcohols of native origin having 12 to 18 carbon atoms, for example of coconut, palm, tallow fatty or oleyl alcohol, and an average of 4 to 8 EO per mole of alcohol are preferred. The preferred ethoxylated alcohols include, for example, C₁₂₋₁₄ alcohols having 4 EO or 7 EO, C₉₋₁₁ alcohol having 7 EO, C₁₃₋₁₅ alcohols having 5 EO, 7 EO or 8 EO, C₁₂₋₁₈ alcohols having 5 EO or 7 EO, and mixtures thereof. Preferred alcohol ethoxylates exhibit a restricted distribution of homologs (narrow range ethoxylates, NRE). In addition to, or instead of, these preferred non-ionic surfactants, fatty alcohols having more than 12 EO can also be used. Examples of these are tallow fatty alcohol having 14 EO, 25 EO, 30 EO, or 40 EO. According to the invention, it is also possible to use non-ionic surfactants that have EO and PO groups in the molecule. Also suitable is a mixture of a (more strongly) branched ethoxylated fatty alcohol and an unbranched ethoxylated fatty alcohol, such as a mixture of a C₁₆₋₁₈ fatty alcohol having 7 EO and 2-propylheptanol having 7 EO. The washing, cleaning, after-treatment or auxiliary washing agent particularly preferably comprises a C₁₂₋₁₈ fatty alcohol having 7 EO or a C₁₃₋₁₅ oxo alcohol having 7 EO as the non-ionic surfactant.

Amine oxides that are preferably used as the non-ionic surfactant have the formula R¹R²R³NO, where R² and R³, independently of one another, denote an optionally substituted C₁ to C₃₀ hydrocarbon functional group, preferably a linear or branched C₁₋₃₀ alkyl group, and especially particularly preferably a linear C₁₋₂₀ alkyl group. In an exceptionally preferred embodiment, R¹ and R² denote a C₁₋₄ alkyl group, more preferably methyl or ethyl, and particularly preferably methyl, and R³ denotes a C₈₋₂₀ alkyl group, preferably a C₁₀₋₁₈ alkyl group, and most preferably a C₁₂₋₁₆ alkyl group.

In a particularly preferred embodiment, the amine oxide is selected from C₁₂-14 alkyl dimethylamine oxide.

It is particularly preferred to use 1 to 15 wt. % of a non-ionic surfactant that is different from the described co-surfactant as the non-ionic surfactant, selected from alkoxylated fatty alcohols having a degree of alkoxylation of ≧4, amine oxides and mixtures thereof, in the washing and cleaning agents according to the invention.

It is preferred that the inorganic salt is selected from the group consisting of sodium chloride, potassium chloride, sodium sulfate, sodium carbonate, potassium sulfate, potassium carbonate, sodium hydrogen carbonate, potassium hydrogen carbonate, calcium chloride, magnesium chloride, and mixtures thereof, since these salts are very easily water-soluble.

It is especially particularly preferred according to the invention when the liquid phase of the washing or cleaning agent according to the invention comprises:
water;
5 to 20 wt. % anionic surfactant selected from the group consisting of sulfonate surfactants, sulfate surfactants and mixtures thereof;
0.4 to 6 wt. % of a co-surfactant selected from a combination of at least one alkoxylated C₈-C₁₈ fatty alcohol having a degree of alkoxylation of ≦3 and at least one aliphatic C₆-C₁₄ alcohol;
1 to 15 wt. % of non-ionic surfactant different from the described co-surfactant, selected from alkoxylated fatty alcohols having a degree of alkoxylation of 4, amine oxides and mixtures thereof; and
0.5 to 10 wt. % of an organic salt.

A second subject matter of the invention relates to a particulate solid matter having an average particle diameter X_{50,3} of 0.01 mm to 3 mm, comprising, based on the total weight:
i) a total amount of 30 to 100 wt. %, preferably 50 to 100 wt. %, and particularly preferably 75 to 100 wt. %, of at least one (preferably anionic) polyester, comprising at least one structural unit of formula (I), at least one structural unit of formula (II), and preferably at least one structural unit of formula (III),

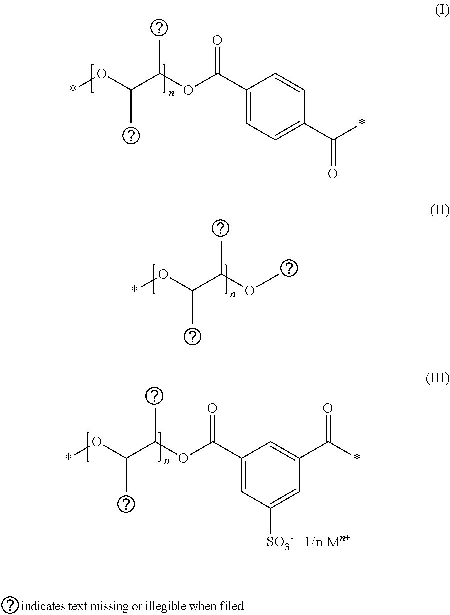

where
a, b and c, independently of one another, each denote a number from 1 to 200;
1/n Mⁿ⁺ denotes an equivalent of a cation having the charge number n, where n=1, 2 or 3;
R¹, R², R³, R⁴, R⁵ and R⁶, independently of one another, each denote hydrogen or a C₁-C₁₆-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group,
ii) a total amount between 0 and 70 wt. %, in particular between 0 and 50 wt. %, and particularly preferably between 0 and 25 wt. %, of at least one further ingredient, selected from plasticizer, plasticizing auxiliary, enzyme, enzyme stabilizer, complexing agent for heavy metals, such as aminopolycarboxylic acids, aminohydroxypolycarboxylic acids, polyphosphonic acids and/or aminopolyphosphonic acids, graying inhibitors, such as cellulose ether, dye transfer inhibitor, such as polyvinylpyrrolidone or polyvinylpyridine-N-oxide, suds suppressor, such as organopolysiloxanes or paraffins, optical brightener, such as stilbene disulfonic acid derivatives, scent, density setting agent, or mixtures thereof.

All preferred embodiments of the suspended solid particles described in the first subject matter of the invention also apply to this second subject matter of the invention.

A third subject matter of the invention relates to the use of the inventive particulate solid matter according to the second subject matter of the invention and a liquid phase, comprising water and surfactant, for producing a liquid washing and cleaning agent.

All preferred embodiments of the suspended solid particles described in the first subject matter of the invention and of the liquid phase also apply to this third subject matter of the invention.

A fourth subject matter of the invention relates a method for producing a liquid washing or cleaning agent, in which inventive particulate solid matter according to the second subject matter of the invention is suspended in a liquid phase, comprising water and surfactant.

For this purpose, the liquid phase is preferably added, and the described particulate solid matter is suspended. Stirring and mixing systems known to a person skilled in the art are suited for this purpose.

All preferred embodiments of the suspended solid particles described in the first subject matter of the invention and of the liquid phase also apply to this fourth subject matter of the invention.

A preferred embodiment of the invention is characterized by the following items:

1. A liquid washing or cleaning agent, comprising:
(i) a liquid phase, comprising at least one surfactant and water, and
(ii) solid particles, suspended in the liquid phase, having a mean particle diameter X_{50,3} of 0.01 mm to 3 mm, comprising, based on the weight of the solid particles, a total amount of 30 to 100 wt. %, preferably 50 to 100 wt. %, and particularly preferably 75 to 100 wt. % of at least one polyester, comprising at least one structural unit of formula (I) and at least one structural unit of formula (II)

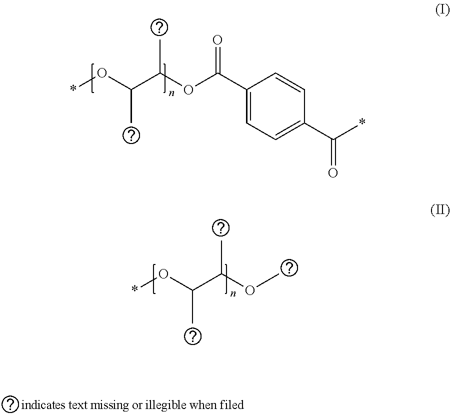

where
a and b, independently of one another, each denote a number from 1 to 200;
R¹, R², R⁵ and R⁶, independently of one another, each denote hydrogen or a C₁-C₁₈-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group.

2. The agent according to item 1, wherein the described at least one polyester present in the suspended solid particle is anionic and additionally comprises at least one structural unit of formula (III)

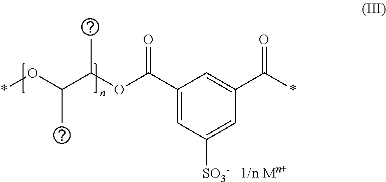

where
b denotes a number from 1 to 200;
1/n Mⁿ⁺ denotes an equivalent of a cation having the charge number n, where n=1, 2 or 3; and
R³ and R⁴, independently of one another, each denote hydrogen or a C₁-C₁₈-n-alkyl group or C₃-C₁₈-iso-alkyl group.

3. The agent according to item 1 or 2, wherein the polyester-containing solid particles suspended in the liquid phase have a mean particle diameter X_{50,3} of 1 mm to 2 mm.

4. The agent according to item 2 or 3, wherein the total amount of the described anionic polyester present in the suspended solid particles has a number average of 1 to 50 structural units of formula (I) and 1 to 50 structural units of formula (III).

5. The agent according to any one of items 1 to 4, wherein the total amount of the described polyester present in the suspended solid particles in each case has a number average between 1 and 25, in particular between 1 and 10, and particularly preferably between 1 and 5 structural units of formula (I), and between 0.05 and 15, in particular between 0.1 and 10, and particularly preferably between 0.25 and 3 structural units of formula (II), optionally between 1 and 30, in particular between 2 and 15, and particularly preferably between 3 and 10 structural units of formula (III).

6. The agent according to any one of items 1 to 5, wherein, in formulas (I), (II) and (III) of the polyester, R¹, R², R³, R⁴, R⁵ and R⁶, independently of one another, each denote hydrogen or methyl.

7. The agent according to any one of items 1 to 6, wherein, in formula (II) of the polyester, R⁷ denotes methyl.

8. The agent according to any one of items 1 to 7, wherein, in formulas (I), (II) and (III) of the polyester, a, b and c, independently of one another, each denote a number from 1 to 200, (in particular 1 to 20, particularly preferably 1 to 5, and exceptionally preferably a and b=1, and c is a number from 2 to 10).

9. The agent according to any one of items 1 to 8, wherein the described polyesters are solid and have softening points above 40° C. (preferably between 50 and 200°, particularly preferably between 80° C. and 150° C., and exceptionally preferably between 100° C. and 120° C.).

10. The agent according to any one of items 1 to 9, wherein additionally at least one further ingredient, selected from plasticizing auxiliary, enzyme, enzyme stabilizer, bleaching agent, bleach activator, complexing agent for heavy metals, graying inhibitor, dye transfer inhibitor, suds suppressor, optical brightener, scents, density setting agents or mixtures of these in the described suspended solid particles.

11. The agent according to any one of items 1 to 10, wherein additionally at least one plasticizing auxiliary is present in the described suspended solid particles, selected from triethyl citrate, triacetin, 1,2-propylene glycol, glycerol, 2-methyl-1,3-propylene glycol, water, or mixtures thereof.

12. The agent according to any one of items 1 to 11, wherein the liquid phase has a yield point.

13. The agent according to any one of items 1 to 12, wherein the liquid phase, based on the total weight of the liquid phase, comprises:
water;
5 to 20 wt. % anionic surfactant selected from the group consisting of sulfonate surfactants, sulfate surfactants and mixtures thereof;
0.4 to 6 wt. % of a co-surfactant selected from the group consisting of alkoxylated C₈-C₁₈ fatty alcohols having a degree of alkoxylation of ≦3, aliphatic C₆-C₁₄ alcohols, aromatic C₆-C₁₄ alcohols, aliphatic C₆-C₁₂ dialcohols, monoglycerides of C₁₂-C₁₈ fatty acids, monoglycerol ethers of C₈-C₁₈ fatty alcohols, and mixtures thereof;
1 to 15 wt. non-ionic surfactant different from the described co-surfactant, preferably selected from the group consisting of alkoxylated fatty alcohols having a degree of alkoxylation ≧4, alkoxylated fatty acid alkyl esters, fatty acid amides, alkoxylated fatty acid amides, polyhydroxy fatty acid amides, alkylphenol polyglycol ethers, amine oxides, alkyl polyglucosides, and mixtures thereof; and
0.5 to 10 wt. % of an organic salt.

14. The agent according to item 13, characterized by comprising 0.4 to 6 wt. % of a co-surfactant selected from a combination of at least one alkoxylated C₈₋₁₈ fatty alcohol having a degree of alkoxylation of ≦3 and at least one aliphatic C₆-C₁₄ alcohol.

15. The agent according to item 13 or 14, characterized by comprising, as the co-surfactant, at least one alkoxylated C₈-C₁₈ fatty alcohol having a degree of alkoxylation of ≦3 in a total amount of 0.4 to 5.0 wt. %, and 0.1 to 1.0 wt. % of at least one aliphatic C₆-C₁₄ alcohol, and in particular at least one branched aliphatic C₆-C₁₄ alcohol.

16. A particulate solid matter having a mean particle diameter X_{50,3} of 0.01 mm to 3 mm, comprising, based on the total weight:

i) a total amount of 30 to 100 wt. %, preferably 50 to 100 wt. %, and particularly preferably 75 to 100 wt. %, of at least one polyester, comprising at least one structural unit of formula (I) and at least one structural unit of formula (II),

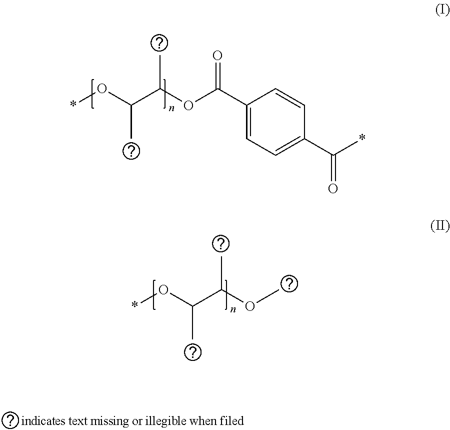

where
a, b and c, independently of one another, each denote a number from 1 to 200;
R¹, R², R⁵ and R⁶, independently of one another, each denote hydrogen or a C₁-C₁₈-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group, and

ii) a total amount between 0 and 70 wt. %, in particular between 0 and 50 wt. %, and particularly preferably between 0 and 25 wt. %, of at least one further ingredient, selected from plasticizer, plasticizing auxiliary, enzyme, enzyme stabilizer, complexing agent for heavy metals, graying inhibitor, dye transfer inhibitor, suds suppressor, optical brightener, scent, density setting agent or mixtures of these.

17. The particulate solid matter according to item 16, comprising, based on the total weight:
i) 50 to 99 wt. % of at least one described polyester; and
ii) 1 to 15 wt. % of at least one plasticizing auxiliary (preferably selected from triethyl citrate, triacetin, 1,2-propylene glycol, glycerol, 2-methyl-1,3-propylene glycol, water, or mixtures thereof); and
iii) 0 to 49 wt. % of at least one further ingredient, selected from enzyme, enzyme stabilizer, complexing agent for heavy metals, graying inhibitor, dye transfer inhibitor, suds suppressor, optical brightener, scent, density setting agent, dye or mixtures thereof

18. Use of a particulate solid matter according to item 16 or 17 and of a liquid phase, comprising water and surfactant, for producing a liquid washing or cleaning agent.

### EXAMPLES

1.0 Production of the Solid Particle

A solid anionic polyester was kneaded in a laboratory kneader, adding small amounts of water in portions, until a plastic mass was obtained. Thereafter, the mass was pressed through a nozzle having a diameter of 1 mm to yield a strand, the strand was cut at intervals of 1.5 mm, and the resulting pieces were rounded and dried for 48 hours at 20° C.

The anionic polyester used essentially comprises structural units corresponding to formulas (I), (II) and (III), where
R¹, R², R³, R⁴, R⁵ and R⁶, independently of one another, each denote hydrogen or methyl;
R⁷ denotes methyl; and
a, b and c, independently of one another, each denote a number from 1 to 5, and
c is a number from 2 to 10,
wherein the total amount of the described anionic polyester present in the suspended solid particles has
between 1 and 5 structural units of formula (I), between 0.25 and 3 structural units of formula (II),
and between 3 and 10 structural units of formula (III).

The described anionic polyester was present in the resulting, rounded solid particles in an amount of more than 95 wt. %.

2.0 Production of a Liquid Washing Agent

The following liquid washing agents were produced by mixing the components:

| | E1 | E2 |
|---|---|---|
| C₁₂-alkylbenzene sulfonic acid | 6.00 | 6.00 |
| C₁₂₋₁₄-alkyl ether sulfate having | 9.59 | 6.00 |
| 2 units of ethylene oxide | | |
| C₁₂₋₁₈ fatty acid | 1.00 | 1.00 |
| C₁₂₋₁₈ fatty alcohol having 7 units | 6.45 | 6.79 |
| of ethylene oxide | | |
| Isotridecanol having 3 units of ethylene | 2.20 | 0.80 |
| oxide | | |
| Isotridecanol | 0.55 | 0.20 |
| Hepta sodium salt of diethylene triamine | 0.25 | 0.20 |
| penta(methylene phosponic acid) | | |
| Citric acid | 2.50 | 2.50 |
| NaOH | 2.24 | 2.24 |
| Defoamer | 0.03 | 0.03 |
| 1,2-propylene glycol | 0.72 | 3.00 |
| Ethanol | 0.06 | 0.22 |
| NaCl | 0.65 | 0.85 |
| K₂SO₄ | 2.00 | 2.00 |
| Tinopal ® CBS-X | 0.10 | 0.10 |
| Amylase | 0.44 | 0.44 |
| Protease | 0.90 | 0.90 |
| Cellulase | 0.17 | 0.17 |
| Mannanase | 0.20 | 0.20 |
| Lipase | 0.20 | 0.20 |
| Pectate lyase | 0.02 | 0.02 |
| Perfume | 0.90 | 0.90 |
| Solid particle according to Example 1 | 0.25 | 0.25 |
| Water | to make up | to make up |
| | to 100 | to 100 |

The washing agents were storage-stable. The solid particles did not dissolve in the washing agent and were suspended in the liquid phase in a stable manner.

What is claimed is:

1. A liquid washing or cleaning agent, comprising:
a liquid phase, comprising at least one surfactant and water, and
(ii) solid particles, suspended in the liquid phase, having a mean particle diameter X_{50,3} of 0.01 mm to 3 mm, comprising, based on the weight of the solid particles, a total amount of 30 to 100 wt. % of at least one polyester, comprising at least one structural unit of formula (I) and at least one structural unit of formula (II) 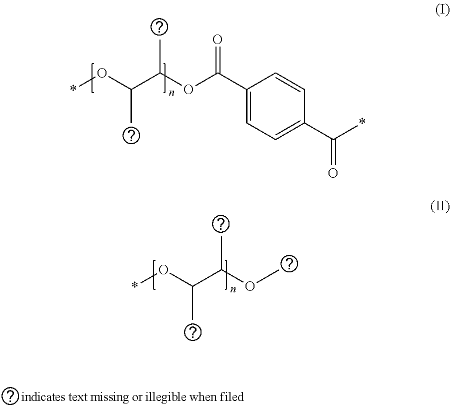
where
a and b, independently of one another, each denote a number from 1 to 200;
R¹, R², R⁵ and R⁶, independently of one another, each denote hydrogen or a C₁-C₁₈-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group.

2. The agent according to claim 1, wherein the described at least one polyester present in the suspended solid particle is anionic and additionally comprises at least one structural unit of formula (III) 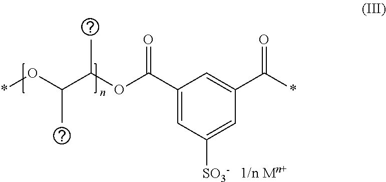
where
b denotes a number from 1 to 200;
1/n Mⁿ⁺ denotes an equivalent of a cation having the charge number n, where n=1, 2 or 3;
R³ and R⁴, independently of one another, each denote hydrogen or a C₁-C₁₈-n-alkyl group or C₃-C₁₈-iso-alkyl group.

3. The agent according to claim 1, wherein the polyester-containing solid particles suspended in the liquid phase have a mean particle diameter X_{50,3} of 1 mm to 2 mm.

4. The agent according to claim 2, wherein the total amount of the described anionic polyester present in the suspended solid particles has a number average of 1 to 50 structural units of formula (I) and 1 to 50 structural units of formula (III).

5. The agent according to claim 1, wherein the total amount of the described polyester present in the suspended solid particles in each case has a number average
between 1 and 25, structural units of formula (I),
between 0.05 and 15 structural units of formula (II), and
optionally between 1 and 30 structural units of formula (III).

6. The agent according to claim 1, wherein, in formulas (I), (II) and (III) of the polyester, R¹, R², R³, R⁴, R⁵ and R⁶, independently of one another, each denote hydrogen or methyl.

7. The agent according to claim 1, wherein, in formula (II) of the polyester, R⁷ denotes methyl.

8. The agent according to claim 1, wherein, in formulas (I), (II) and (III) of the polyester, a, b and c, independently of one another, each denote a number from 1 to 200.

9. The agent according to claim 1, wherein the described polyesters are solid and have softening points above 40° C.

10. The agent according to claim 1, wherein additionally comprising at least one further ingredient, selected from the grouping consisting of plasticizing auxiliary, enzyme, enzyme stabilizer, bleaching agent, bleach activator, complexing agent for heavy metals, graying inhibitor, dye transfer inhibitor, suds suppressor, optical brightener, scents, and density setting agents.

11. The agent according to claim 1, further comprising at least one plasticizing auxiliary present in the described suspended solid particles, selected from triethyl citrate, triacetin, 1,2-propylene glycol, glycerol, 2-methyl-1,3-propylene glycol, water, or mixtures thereof.

12. The agent according to claim 1, wherein the liquid phase has a yield point.

13. The agent according to claim 1, wherein the liquid phase, based on the total weight of the liquid phase, comprises:
water;
5 to 20 wt. % anionic surfactant selected from the group consisting of sulfonate surfactants, sulfate surfactants and mixtures thereof;
0.4 to 6 wt. % of a co-surfactant selected from the group consisting of alkoxylated C₈-C₁₈ fatty alcohols having a degree of alkoxylation of ≦3, aliphatic C₆-C₁₄ alcohols, aromatic C₆-C₁₄ alcohols, aliphatic C₆-C₁₂ dialcohols, monoglycerides of C₁₂-C₁₈ fatty acids, monoglycerol ethers of C₈-C₁₈ fatty alcohols, and mixtures thereof;
1 to 15 wt. non-ionic surfactant different from the described co-surfactant, selected from the group consisting of alkoxylated fatty alcohols having a degree of alkoxylation ≧4, alkoxylated fatty acid alkyl esters, fatty acid amides, alkoxylated fatty acid amides, polyhydroxy fatty acid amides, alkylphenol polyglycol ethers, amine oxides, alkyl polyglucosides, and mixtures thereof; and
0.5 to 10 wt. % of an organic salt.

14. A particulate solid matter having a mean particle diameter X_{50,3} of 0.01 mm to 3 mm, comprising, based on the total weight:
i) a total amount of 30 to 100 wt. %, of at least one polyester, comprising at least one structural unit of formula (I) and at least one structural unit of formula (II), 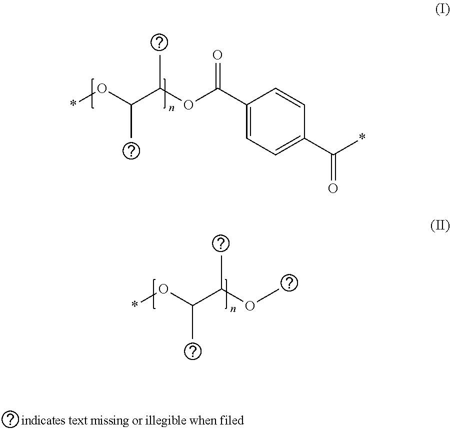
where
a, b and c, independently of one another, each denote a number from 1 to 200;
R¹, R², R⁵ and R⁶, independently of one another, each denote hydrogen or a C₁-C₁₈-n-alkyl group or C₃-C₁₈-iso-alkyl group; and
R⁷ denotes a linear or branched C₁-C₃₀ alkyl group, or a linear or branched C₂-C₃₀ alkenyl group, a cycloalkyl group having 5 to 9 carbon atoms, a C₆-C₃₀ aryl group, or a C₆-C₃₀ arylalkyl group, and
ii) a total amount between 0 and 70 wt. %, of at least one further ingredient, selected from plasticizer, plasticizing auxiliary, enzyme, enzyme stabilizer, complexing agent for heavy metals, graying inhibitor, dye transfer inhibitor, suds suppressor, optical brightener, scent, density setting agent or mixtures of these.

15. The particulate solid matter according to claim 14, comprising, based on the total weight:
i) 50 to 99 wt. % of at least one described polyester; and
ii) 1 to 15 wt. % of at least one plasticizing auxiliary, and
iii) 0 to 49 wt. % of at least one further ingredient, selected from enzyme, enzyme stabilizer, complexing agent for heavy metals, graying inhibitor, dye transfer inhibitor, suds suppressor, optical brightener, scent, density setting agent, dye or mixtures thereof.
